(19) United States
(12) Patent Application Publication
(10) Pub. No.: US 2008/0152919 A1
(43) Pub. Date: Jun. 26, 2008

(54) Resistive implant welding for structural bonds in automotive applications

(75) Inventors: Steven Grgac, Mississauga (CA); David D. Rouison, Brampton (CA); Martin McLeod, Barrie (CA)

Correspondence Address: WARN, HOFFMANN, MILLER & LALONE, .P.C, PO BOX 70098, ROCHESTER HILLS, MI, 48307, US

(73) Assignee: Magna International Inc., Aurora (CA)

(21) Appl. No.: 11/644,209

(22) Filed: Dec. 22, 2006

(51) Int. Cl. B32B 9/04

(52) U.S. Cl. 428/411.1

(57) ABSTRACT

A fused component having a first portion and second portion made of polymer material. Between the first portion and second portion is a conductor and a weld line is formed between said first portion and said second portion along the surface area of the conductor. The weld line has a strength of equal to or greater than 800 psi. The fused component formed can be any type of automotive component such as a tailgate, running board, roof rail, liftgate, or front end carrier.

### FIELD OF THE INVENTION

The present invention relates to the use of resistive implant welding for structural welds in automotive applications.

### BACKGROUND OF THE INVENTION

The joining together of two or more plastic components to form a weld or joint is frequently required during the manufacturing automobile components. As the use of plastic material in automotive applications increases there exists a greater need for more ways of welding together such components. One particular requirement is that the weld formed must have a sufficient amount of weld strength. In particular, in vehicle tailgates, such as pick-up truck tailgates the component must be designed to withstand great loads. In order to meet load requirements, composite tailgates are designed as a hollow structure having several reinforcement ribs and flange supports in combination with reinforcement sheets. For tailgates that are formed of thermoplastic composites, the various reinforcement sheets and supportive ribs of the tailgate are fused together using adhesives specially formulated to have high weld strength. The use of such adhesives does add to the length of the manufacturing time due to the time it takes to cure the weld. Also, the adhesives can be costly and contribute to the overall cost of producing the tailgate. Yet other adhesives are less costly and have a faster cure time, they require surface treatments (e.g., corona treatment or plasma treatment) to increase the surface energy of welding faces. These surface treatments are a secondary operation and difficult to control and increase part cost. Therefore, there exists a need to form welds between thermoplastic components that will decrease manufacturing time by reducing the time needed to form the weld, as well as eliminate costly adhesives.

### SUMMARY OF THE INVENTION

A fused component having a first portion and second portion made of polymer material. Between the first portion and second portion is a conductor and a weld line is formed between said first portion and said second portion along the surface area of the conductor. The weld line has a strength of equal to or greater than 800 psi. The fused component formed can be any type of automotive component such as a tailgate, running board, roof rail, liftgate, front end carrier, decorative panels or airbag deployment doors.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of an exemplarily resistive implant welding machine;

FIG. 2 is a perspective close up view of a fused component being formed in the resistive implant welding machine;

FIG. 3 is a perspective view of a fused component formed as one half of a vehicle tailgate;

FIG. 4 is a cross-sectional view of a first component being fused to a second component; and

FIG. 5 is a plan side view of a first component being fused to a second component.

### DETAILED DESCRIPTION OF THE PREFERRED EMBODIMENTS

The following description of the preferred embodiment(s) is merely exemplary in nature and is in no way intended to limit the invention, its application, or uses.

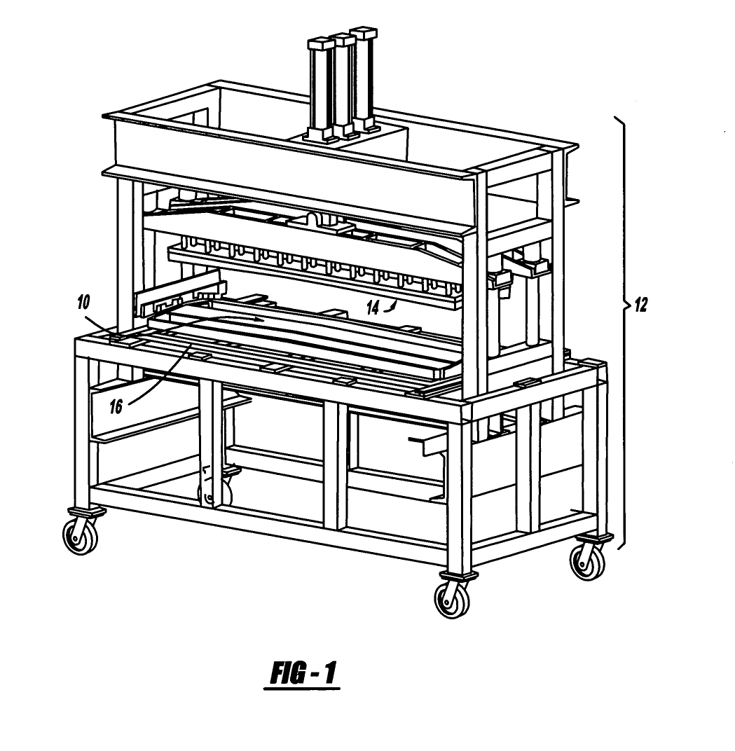

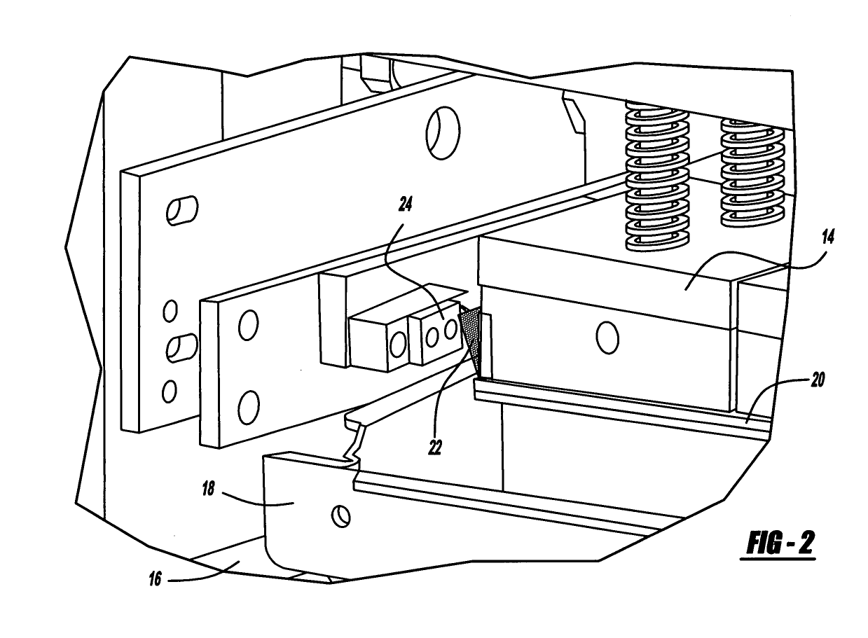

Referring now to FIGS. 1-2 a method for forming a fused or welded component using resistive implant welding is depicted. A fused component 10 is shown in a resistive implant welding machine 12. The resistive welding machine 12 has an upper platen 14 capable of moving vertically with respect to the fused component 10. The resistive implant welding machine 12 also has a lower platen 16 upon which the fused component 10 rests and is formed. When the fused component 10 is to be welded the upper platen 14 will move vertically and press down against the fused component 10 and apply pressure.

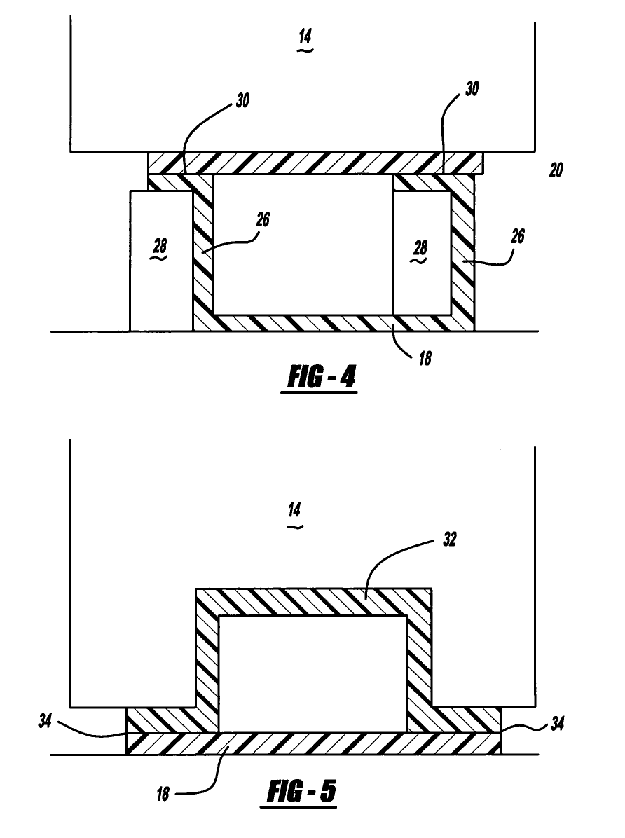

FIG. 2 shows a close up view wherein the upper platen 14 is pressed down against the fused component 10. The fused component 10 has a first portion 18, a second portion 20 and a conductor 22 placed between the first portion 18 and the second portion 20. The first portion 18 and second portion 20 can take many shapes and forms depending upon the particular application of the invention. This will be discussed in greater detail with reference to FIGS. 4-5.

The conductor 22 comes into contact with an energy source 24 which can be copper contacts or conductors that energize the conductor 22. The conductor 22 can be wire mesh or some other type of electrically conductive material capable of generating heat when an electrical current is applied. Additionally the conductor 22 can be a single wire. When the upper platen 14 moves down and compresses the first portion 18 and second portion 20 the energy source 24 applies energy to the conductor 22 which causes the conductor to heat up. The heating of the conductor 22 causes the first portion 18 and second portion 20 to weld together as molten material flows around the wire mesh conductor 22. The heating of the conductor 22 causes portions 18 and 20 to start melting. The pressure applied force on the molten portions 18 and 20 causes the molten portions to flow around the wire mesh conductor and mix together. The heat generated by the conductor 22 combined with the pressure applied by the upper platen 14 to the lower platen 16 causes the weld line to form.

After the pressing and energizing operation has occurred for a predetermined time period the first portion 18 and second portion 20 will be allowed to solidify by cooling to form a weld line. During the forming process the surfaces of the first portion 18 and second portion 20 that are exposed to the conductor 22 are heated and melt or weld the first and second portions together. The conductor 22 will remain in the fused component 10 at the weld line. The use of wire mesh as the conductor 22 provides holes for the molten plastic material of the first and second components 18, 20 to cure together. The weld line formed between the first portion 18 and second portion 20 will have a high weld strength, that has been shown to be equal or greater than the type of weld strength obtained using adhesives or mechanical fasteners. Furthermore, the manufacturing time for forming the weld between the first portion 18 and second portion 20 is much shorter than the manufacturing time forming a similar weld using adhesives.

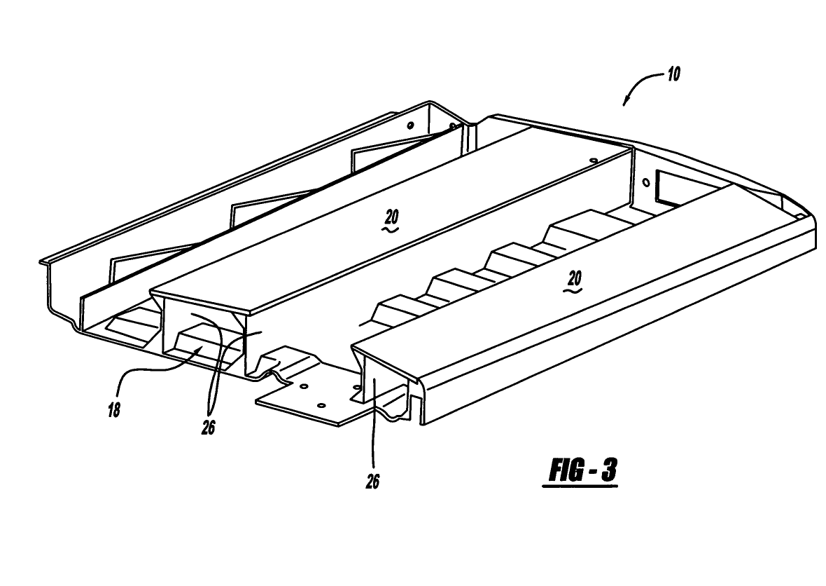

Referring to FIG. 3 a view of a moulded tailgate is shown wherein the first portion 18 is the moulded tailgate portion and the second portion 20 is a reinforcement sheet that strengthens the fused component 10. The first portion 18 has tailgate flanges 26 extending from the first portion 18. The second portion 20 or reinforcement sheet is placed across one or more of the tailgate flanges 26. The conductor (not shown) is placed along the contact area between the tailgate flanges 26 and the second portion 20. The weld line is formed along the length of the surface area of the conductor 22. The placement of the reinforcement sheet strengthens the fused component. For example, a tailgate as moulded in a manner described with respect to the present application can withstand loads greater or less than 2,200 lbs. However, 2,200 lbs. is merely exemplary number and depending on the specification the load can be greater or lesser.

Referring now to FIG. 4 a cross-sectional view of a portion of the tailgate shown in FIG. 3 is shown. The first portion 18 is a moulded tailgate portion having tailgate flanges 26 extending upward from the surface. The second portion 20 is resistive implant welded onto the first portion. The upper platen 14 is shown and applies pressure during the moulding process. In this particular application rigid supports 28 are inserted under portions of the tailgate flanges in order to facilitate and even the weld of the first portion 18 to the second portion 20. The rigid supports 28 can be removed after the welding process is complete. A weld line 30 is formed between the tailgate flanges 26 and the second portion 20. Although the use of rigid supports 28 are described above, it is not necessary to use them in all applications. It is possible to form weld without the use of rigid supports 28.

FIG. 5 shows an alternate embodiment of the invention wherein there are no tailgate flanges 26; instead a U-Shaped second portion 32 is welded onto the first portion 18 which is a moulded tailgate. This particular embodiment eliminates the need for using rigid supports 28. The upper platen 14 is modified to fit around the U-Shaped second portion 32 and apply pressure at the appropriate location where a weld line 34 between the first portion 18 and the U-Shaped second portion 32 is desired.

The embodiment disclosed in FIGS. 4 and 5 can be used in other applications besides forming tailgates; it is possible to form any type of structural plastic parts. For example, in both applications set forth in FIGS. 4 and 5, the first portion 18 can be a moulded liftgate, while the second portion 20 or U-Shaped second portion 32 can be a reinforcement sheet or a moulded reinforcement for a moulded liftgate. Another application involves the first portion 18 being a top half of a running board while the second portion 20 or U-Shaped second portion 32 can be the bottom half of a running board. In another application the first portion 18 can be one half of a roof rail while the second portion 20 or U-Shaped second portion 32 can be a second half of a roof rail. In yet another application of the present invention, the first portion 18 can be a carrier module for a vehicle front end, while the second potion 20 or U-Shaped second portion 32 can be a resistively implant welded support beam. The invention described above can also be used to form airbag deployment chutes to instrument panel toppers or for welding decorative appliqués or exterior skins to panels, running boards, liftgates or tailgates, thus eliminating the need for using fasteners.

The description of the invention is merely exemplary in nature and, thus, variations that do not depart from the gist of the invention are intended to be within the scope of the invention. Such variations are not to be regarded as a departure from the spirit and scope of the invention.

1. A component comprising:
a fused component one selected from a group comprising running boards, roof rails, tailgates, front end carriers, liftgates, airbag deployment chutes fused to instrument panel toppers, or fused decorative appliqués or exterior skins to panels, wherein said fused component comprises two or more portions; and
a conductor placed in between each of said two or more portions wherein said two or more portions are fused together along the surface area of said conductor forming a weld line.

2. The fused component of claim 1 wherein said conductor is wire mesh capable of conducting energy.

3. The fused component of claim 1 wherein one portion of said two or more portions is a top half of a running board and a second portion of said two or more portions is a bottom half of a running board that will be resistive implant welded to said top half of said running board.

4. The fused component of claim 1 wherein one portion of said two or more portions is a moulded liftgate and a second portion of said two or more portions is a reinforcement sheet or exterior decorative skin for attachment to said moulded liftgate.

5. The fused component of claim 1 wherein one portion of said two or more portions is a moulded tailgate and a second portion of said two or more portions is a moulded reinforcement fused to said moulded tailgate.

6. The fused component of claim 1 wherein one portion of said two or more portions is one half of a roof rail, while a second portion of said two or more portions is a second half of a roof rail that is resistive implant welded to said first half of said roof rail.

7. A fused component comprising:
a first portion of plastic material;
a second portion plastic material; and
a conductor placed between said first portion and said second portion wherein said first and second portions are fused along the surface area of said conductor to form a weld line having a strength greater than or equal to 800 psi.

8. The fused component of claim 7 wherein said first portion is a tailgate flange.

9. The fused component of claim 8 wherein said second portion is a reinforcement sheet.

10. The fused component of claim 7 wherein said conductor is wire mesh capable of conducting energy.

11. The fused component of claim 7 wherein said first portion is a moulded tailgate and said second portion is a moulded reinforcement fused to said moulded tailgate.

12. The fused component of claim 11 wherein said conductor is wire mesh capable of conducting energy and facilitating the welding of the first portion and the second portion.

13. The fused component of claim 7 wherein said fused component is one selected from a group comprising running boards, roof rails, liftgates, front end carriers, airbag deployment chutes to instrument panel toppers, or welding decorative appliqués to or exterior skins to panels.

14. The fused component of claim 7 wherein said first portion is a moulded liftgate and said second portion is a reinforcement sheet or exterior decorative skins for attachment to said moulded liftgate.

15. The fused component of claim 7 wherein said first portion is a top half of a running board and said second portion is a bottom half of a running board that will be resistive implant welded to said top half of said running board.

16. The fused component of claim 7 wherein said first portion is one half of a roof rail, while said second portion is a second half of a roof rail that is resistive implant welded to said first half of said roof rail.

17. The fused component of claim 7 wherein said first portion is a lower portion of a carrier module and said second portion is a support beam for being resistive implant welded to an upper reinforcement portion of said carrier module.

18. A fused component comprising:
a tailgate flange formed of a polymer material;
a reinforcement sheet formed of a polymer material; and
a conductor placed between said tailgate flange and said reinforcement sheet wherein said tailgate flange and said reinforcement sheet are fused along the surface area of the conductor to formed said fused component.

19. The fused component of claim 18 wherein said conductor is wire mesh capable of conducting energy and said wire mesh is embedded within said weld line of said fused component.

20. The fused component of claim 18 wherein said fused component is capable of withstanding forces equal to or greater than 2,200 lbs.
